(19) United States
(12) Patent Application Publication
(10) Pub. No.: US 2007/0030970 A1
(43) Pub. Date: Feb. 8, 2007

(54) Digital signature system

(76) Inventors: Dennis C. DeYoung, Webster, NY (US); Steven J. Harrington, Webster, NY (US)

Correspondence Address: Clifford P. Kelly;Alix, Yale & Ristas, LLP, 750 Main Street, Hartford, CT, 06103-2721, US

(21) Appl. No.: 11/198,427

(22) Filed: Aug. 5, 2005

(51) Int. Cl. H04N 1/44

(52) U.S. Cl. 380/246

(57) ABSTRACT

A method of a signer affixing a physical manifestation of a digital signature to a hard-copy document includes inputting a digital copy of the hard-copy document into a secure hash function stored on a computer to produce a message digest. The message digest and a private key of the signer are input into a digital signature generation algorithm stored on the computer to generate an electronic digital signature. The electronic digital signature is transmitted from the computer to a printing device. Finally, the physical manifestation of a digital signature is printed on the hard-copy document with the printing device.

### BACKGROUND

This disclosure relates generally to the authentication and non-repudiation of hard-copy communications. More particularly, the present disclosure relates to an apparatus and method for producing a digital signature.

Many business activities require execution of various documents, typically by signature. Signing such documents serves a number of purposes. A signature authenticates a writing by identifying the signer with the signed document. In certain contexts, the signature expresses the signer's approval or authorization of the writing, or the signer's intention that it have legal effect. Such authentication also enables the receiver to prove to a third party, such as a judge, that the document was created by the purported sender. This latter ability prevents the sender from repudiating a genuine document, such as a promise to pay, by falsely claiming that it is a forgery created by the receiver. A signature on a written document often imparts a sense of clarity and finality to the transaction and may lessen the subsequent need to inquire beyond the face of a document. Negotiable instruments, for example, rely upon formal requirements, including a signature, for their ability to change hands with ease, rapidity, and minimal interruption. The act of signing a document calls to the signer's attention the legal significance of the signer's act, and thereby helps prevent inconsiderate engagements. Consequently, sound practice calls for transactions to be formalized in a manner which assures the parties of their validity and enforceability.

Until a few years ago, formalization generally involved documenting the transaction on paper and signing or authenticating the paper. Although the basic nature of transactions has not changed, business conditions have required an increasing reliance on digital documents. Ordinary digital documents lack the verifiable authenticity of paper documents in two respects. First, they can be forged by third parties claiming to be the purported sender, or be subjected to undetectable modification in transit. Second, a genuine document can later be repudiated by the actual sender, who may falsely claim that the document is a forgery created by the receiver.

Digital signatures have been used for some time on digital documents to provide the two main functions of an ink signature on a paper document, namely “authentication” and “non-repudiation”. Most digital signature schemes use public key cryptography to provide authentication and non-repudiation for transmitted data. Typical digital signatures created via an asymmetric key algorithm can be validated by anyone knowing the public-key of the sender.

U.S. patent application Ser. No. 11/131,641, filed May 18, 2005, for a “Digital Signature/certificate for Hard-copy Documents” discloses a hard-copy authentication document, which is a physical manifestation of a digital signature or a physical manifestation of a public key affixed to a hard-copy document or physical object, respectively, and a method of authentication and non-repudiation of hard-copy documents, which includes affixing a physical manifestation of a digital signature to a hard-copy document. However, such application does not disclose apparatus for writing the digital signature that could provide the signer with the same feeling of authorship and security as is found when signing ones name.

### SUMMARY

There is provided a method of a signer affixing a physical manifestation of a digital signature to a hard-copy document. The method comprises inputting a digital copy of the hard-copy document into a secure hash function stored on a computer to produce a message digest. The message digest and a private key of the signer are input into a digital signature generation algorithm stored on the computer to generate an electronic digital signature. The electronic digital signature is transmitted from the computer to a printing device. Finally, the physical manifestation of a digital signature is printed on the hard-copy document with the printing device.

The method may further comprise authenticating the identity of the signer before printing the physical manifestation of a digital signature. Authenticating the identity of the signer may include requiring the signer to enter a PIN number on an input device and comparing the PIN number to an exemplar PIN number of record. Alternatively, authenticating the identity of the signer may include requiring the signer to enter at least one biometric sample into an input device and comparing the biometric sample to an exemplar biometric sample of record. The biometric sample may be a fingerprint, a digital photograph, a voice sample, or a retinal scan.

The method may further comprise switching the printing device to a conventional writing mode and printing with the printing device. Switching the printing device to a conventional writing mode includes entering a code or voice command at the computer. Before printing, the computer queries whether the printing device is in a digital signature mode and generates conventional printing commands if the printing device has been switched to the conventional writing mode. The computer generates printing commands to the printing device to produce the physical manifestation of a digital signature if the printing device has not been switched to the conventional writing mode.

The method of a signer affixing a physical manifestation of a digital signature to a hard-copy document may be included in a method of authentication and non-repudiation of hard-copy documents. This method comprises affixing a physical manifestation of a digital signature to a hard-copy document as described above. The physical manifestation of a digital signature is then converted to an electronic digital signature. The electronic digital signature is validated with a public key to authenticate the hard-copy document.

### BRIEF DESCRIPTION OF THE DRAWINGS

The present disclosure may be better understood and its numerous objects and advantages will become apparent to those skilled in the art by reference to the accompanying drawings in which:

FIG. 1 is a schematic diagram of apparatus for creating a physical manifestation of the digital signature/digital certificate;

FIG. 2 is an embodiment of a conventional hand-held pen printer;

FIG. 3 is a flow diagram of a method for creating a physical manifestation of the digital signature/digital certificate; and

FIG. 4 is a flow diagram of a method of utilizing the hand-held printer for applying physical representations of digital signatures and for conventional printing.

### DETAILED DESCRIPTION

U.S. patent application Ser. No. 11/131,641, filed May 18, 2005, for a “Digital Signature/Certificate for Hard-copy Documents”, the disclosure of which is incorporated herein by reference in its entirety, discloses a hard-copy authentication document, which is a physical manifestation of a digital signature or a physical manifestation of a public key affixed to a hard-copy document or physical object, respectively, and a method of authentication and non-repudiation of hard-copy documents, which includes affixing a physical manifestation of a digital signature to a hard-copy document.

The term “physical manifestation of a digital signature” is hereby defined as a machine readable format bound to the document, such as through printing, having a capacity sufficient to display the complete data content of a digital signature meeting the criteria of applicable industry standards. One such physical manifestation is a printed representation of the digital signature in a 2D barcode. Two dimensional (2D) symbologies first appeared in 1988 when Code 49 was introduced by Intermec. Two dimensional barcodes can be classified into several types, with stacked and matrix being the most prevalent. Some of the advantages of 2D over one-dimensional (1 D) barcodes are the physical size, storage capability and data accuracy. One example of a 2D barcode is Adobe's PDF-417 2D barcode. Another such physical manifestation is a print of the digital signature in Xerox DataGlyphs™. The term “hard-copy document” is hereby defined as any artifact bearing information that may carry a physical manifestation of a digital signature.

The Digital Signature/Certificate for Hard-copy Documents application discloses that digital signatures can be printed on a label that could then be affixed to the document being signed. Alternatively, the signature might be printed directly on the document by running it through a conventional printer. However, both of these methods have limitations. A label might become unattached or it might be transferred to a different document. Bound documents can not be fed through conventional printers. Conventional printers would also require guidance as to where to place the signature. What is desired is a way for the person signing the document to add his or her signature wherever desired with as much ownership and security as a conventional signature with a pen.

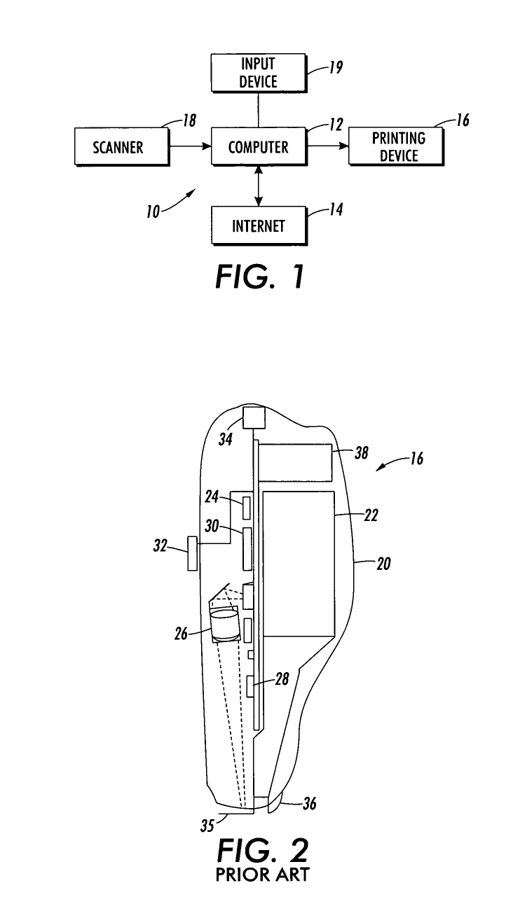

With reference to the drawings wherein like numerals represent like parts throughout the several figures, and more particularly to FIG. 1, there is shown an apparatus 10 for creating a digital signature/certificate for use on a hard-copy document. The apparatus 10 comprises a computer system 12, including a keyboard, a display and a mouse (none of which are shown), and is connected to the Internet 14. In addition, the computer system 12 includes a printing device 16, a scanning device 18, and an input device 19, as explained in greater detail below.

The printing device 16 of the subject disclosure is a printing device that produces the digital signature. The term “printing device” is hereby defined as any device that is capable of printing or applying a digital signature directly on a hard-copy document. Such printing devices include fixed-position printers having the capacity for receiving the hard-copy document on which the digital signature is to be printed. Portable printing devices having a similar capacity may also be used. Hand-held printers, such as the mouse printer, described in U.S. Pat. No. 5,927,872 to Yamada, issued Jul. 27, 1999, are particularly suited to the subject method since such printers may be used with any size hard-copy document. Another hand-held printer is a pen printer, described in U.S. Pat. No. 6,626,593 to Doberenz, issued Sep. 30, 2003, is shown in FIG. 2. In this example, the printing device comprises a casing 20, which contains an ink dispenser 22, a circuit 24 that controls the ink dispenser, a switch 32, and a movement sensor 26. The printing device may also include a memory 30, a power source 38, a microcontroller 28, and ink-curing component 36 and a connector 34.

The printing device 16 receives image data through the connector 34. The image data may or may not be stored by a memory 30, depending upon the speed of the connection and the speed of the print drive electronics in converting the image data signals into ink sprayed out the nozzle. Once the image data is provided, the print drive circuit 24 converts it into the necessary control signals to operate the ink dispenser. The microcontroller 28 provides finer controller of the electronics or addition of special print processes.

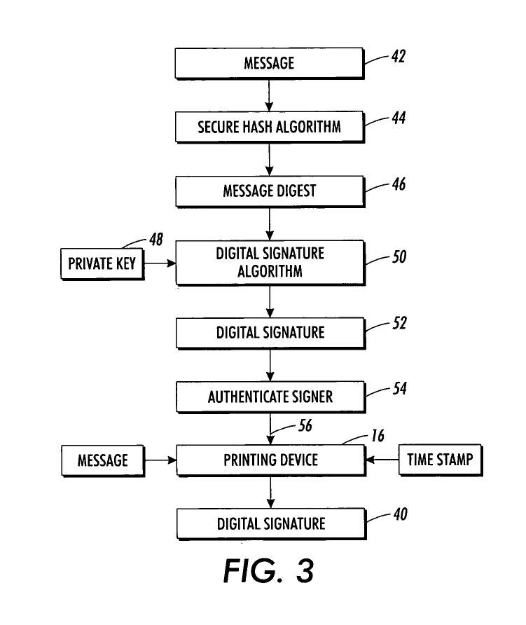

When the user has positioned the printing device 16 in the appropriate spot, an initial position switch is triggered. As shown in FIG. 2, the initial position switch 32 may be situated on the outside of the casing 22 in a location convenient to the user's fingertips. Alternatively, the initial position switch 32 could be positioned on the tip of the printing device, near the nozzle 35. The user would then trigger the switch by pressing down with a little extra force to locate the origin. The user triggers the switch 32 to start the printing. The user then sweeps the printing device 16 across the signature field of the document to apply the digital signature 40 (FIG. 3). The movement sensor 26 tracks the movement of the printing device 16.

With reference to FIG. 3, a digital copy of the document 42 that is to be digitally signed (hereinafter “the message”) is input into a secure hash function 44 to produce a condensed version of the message, hereinafter “the message digest” 46. The secure hash function 44, the message digest 46 and a private key 48 of the signer are then input to the digital signature algorithm 50 to generate an electronic digital signature 52. Other information, such as the time/date, the signer's name, a URL reference to an original version in a repository that may be under change management, or any other desired metadata may also be input to the digital signature algorithm 50 before the electronic digital signature 52 is generated. The private key 48 may be an encryption key or any password, data, code, pointer, PIN, or the like, that is useful in decrypting information or otherwise converting information into a different form.

To ensure that the digital signature corresponds to the identity of the signer, the identity of the signer is verified 54 before the digital signature is printed. Such identity verification 54 can be performed by simply requiring the signer to enter a PIN number on the input device 19, for example a keypad or keyboard, and comparing the PIN number to an exemplar PIN number of record. For greater security biometrics, such as fingerprint analysis, retinal scan comparison, visual comparison, or voice recognition may be used. The input device 19 for this method of confirmation of identity and construction of the signature might be a microphone (for voice recognition), digital camera (for visual comparison), or a special purpose fingerprint scanner. All of which may be connected directly to the computer 12 as shown in FIG. 1. If appropriate, scanner 18 may be used in place of a special purpose fingerprint scanner. Alternatively, confirmation of identity could take place within the hand-held printer 16′ itself, provided the hand-held printing device 16′ is equipped with a suitable input device 19′. After the identity of the signer has been confirmed 56, the hand-held printing device 16 is swept across the signature field of the hard-copy document to apply a physical manifestation of the digital signature 40 to the hard-copy of the document.

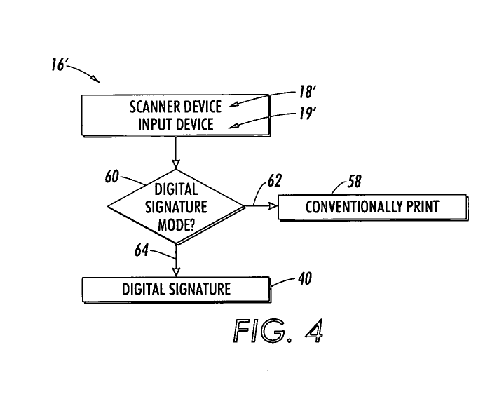

With reference to FIG. 4, the hand-held printer may 16′ also have a conventional writing mode that would allow it to be used for conventional printing 58 as well. The hand-held printer 16′ may be switched between the digital signature mode and the conventional printing mode by entry of a code or voice command at the computer 12. Before initiating a print command, the computer 12 queries 60 whether the hand-held printer 16′ is in the digital signature mode. If the user has switched the hand-held printer 16′ to the conventional printing mode 62, the computer 12 generates conventional printing commands 58 to the hand-held printer 16′. If the user has not switched the hand-held printer 16′ to the conventional printing mode 64, the computer 12 generates printing commands to the hand-held printer 16′ that will produce the digital signature 40.

Integration of a scanner 18′ to the hand-held printing device 16′ would allow for digital signatures and certificates to be read back and verified also. Common fields could then also be identified and completed by the hand-held printing device 16′ if they were color coded or marked in some way the hand-held printing device 16′ could recognize.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of a signer affixing a physical manifestation of a digital signature to a hard-copy document comprises:
inputting a digital copy of the hard-copy document into a secure hash function stored on a computer to produce a message digest;
inputting the message digest and a private key of the signer into a digital signature generation algorithm stored on the computer to generate an electronic digital signature;
transmitting the electronic digital signature from the computer to a printing device; and
printing the physical manifestation of a digital signature on the hard-copy document with the printing device.

2. The method of claim 1 further comprising authenticating the identity of the signer before printing the physical manifestation of a digital signature on the hard-copy document with the printing device.

3. The method of claim 2 wherein authenticating the identity of the signer includes:
requiring the signer to enter a PIN number on an input device; and
comparing the PIN number to an exemplar PIN number of record.

4. The method of claim 2 wherein authenticating the identity of the signer includes:
requiring the signer to enter at least one biometric sample into an input device; and
comparing the biometric sample to an exemplar biometric sample of record.

5. The method of claim 4 wherein the biometric sample is a fingerprint.

6. The method of claim 4 wherein the biometric sample is a digital photograph.

7. The method of claim 4 wherein the biometric sample is a voice sample.

8. The method of claim 4 wherein the biometric sample is a retinal scan.

9. The method of claim 1 further comprising:
switching the printing device to a conventional writing mode; and
printing with the printing device.

10. The method of claim 9 wherein switching the printing device to a conventional writing mode includes entering a code or voice command at the computer.

11. The method of claim 9 wherein before printing, the computer:
queries whether the printing device is in a digital signature mode; and
generates conventional printing commands if the printing device has been switched to the conventional writing mode.

12. The method of claim 11 wherein the computer generates printing commands to the printing device to produce the physical manifestation of a digital signature if the printing device has not been switched to the conventional writing mode.

13. The method of claim 1 wherein the printing-device is a hand-held printing device.

14. A method of a signer affixing a physical manifestation of a digital signature to a hard-copy document comprises:
inputting a digital copy of the hard-copy document into a secure hash function stored on a computer to produce a message digest;
inputting the message digest and a private key of the signer into a digital signature generation algorithm stored on the computer to generate an electronic digital signature;
authenticating the identity of the signer;
transmitting the electronic digital signature from the computer to a printing device; and
printing the physical manifestation of a digital signature on the hard-copy document with the printing device.

15. The method of claim 14 further comprising:
switching the printing device to a conventional writing mode; and
printing with the printing device.

16. The method of claim 14 wherein the printing-device is a hand-held printing device.

17. A method of authentication and non-repudiation of hard-copy documents comprising:
affixing a physical manifestation of a digital signature to a hard-copy document including
inputting a digital copy of the hard-copy document into a secure hash function to produce a message digest,
inputting the message digest and a private key of an originator of the hard-copy document into a digital signature generation algorithm to generate an electronic digital signature,
inputting the electronic digital signature into a printing device, and
printing the physical manifestation of a digital signature on the hard-copy document with the printing device;
converting the physical manifestation of a digital signature to an electronic digital signature; and
validating the electronic digital signature with a public key to authenticate the hard-copy document.

18. The method of claim 17 further comprising authenticating the identity of the signer before printing the physical manifestation of a digital signature on the hard-copy document with the printing device.

19. The method of claim 17 wherein the printing-device is a hand-held printing device.
